(19) United States
(12) Patent Application Publication
(10) Pub. No.: US 2014/0004914 A1
(43) Pub. Date: Jan. 2, 2014

(54) WATERPROOF DEVICE FOR AN ELECTRONIC PRODUCT

(71) Applicant: Will Wu, Shenzhen City (CN)

(72) Inventor: Will Wu, Shenzhen City (CN)

(21) Appl. No.: 13/539,757

(22) Filed: Jul. 2, 2012

(51) Int. Cl. H04W 88/02

(52) U.S. Cl. 455/575.8

(57) ABSTRACT

A waterproof device with small thickness, light weight, simple structure and small influence on heat radiation for an electronic product is disclosed. The waterproof device includes: a panel with one side of the panel attached closely to one surface of the electronic product, and with a peripheral opening groove; and a silicone sleeve attached closely to the other surfaces of the electronic product, wherein the silicone sleeve has an opening extending towards a contact surface between the electronic product and the panel, and a flange of the opening of the silicone sleeve is embedded into the peripheral opening groove of the panel. The waterproof device greatly reduces the usage of panel materials and effectively reduces the thickness, weight and cost of the products by setting the combination of a silicone sleeve and a panel. The waterproof device forms an internal closed cavity to accommodate the electronic product which needs waterproof.

### FIELD OF THE INVENTION

The invention relates to a waterproof device for an electronic product, and in particular to a simple structured and flimsy waterproof device for an electronic product.

### BACKGROUND OF THE INVENTION

Electronic products are more and more durable due to the development of the production process, the enrichment of the materials and the improvement of the structure. When in normal usage, the existing electronic products are very durable, but usually electronic products are disposable after they touch water. In the condition of increasingly improved performance of electronic products, their poor waterproof capability is more and more prominent.

Generally, the waterproof design for electronic products on current market is to coat the entire electronic product with a plastic shell, and this type of design has complicated structure, great thickness of the plastic shell and a certain weight. It brings inconvenience to use, and this type of plastic shell usually brings inconvenience to the heat radiation of the electronic product.

### SUMMARY OF THE INVENTION

Therefore, it is an object of the present invention to overcome the above problems of waterproof designs for the electronic products which have complicated structure and great thickness, and to provide a waterproof device with small thickness, light weight, simple structure and small influence on heat radiation of electronic products.

To achieve the above object, the technical solution is as follows:

a waterproof device for an electronic product, comprises:

a panel with one side of the panel attached closely to one surface of the electronic product, and with a peripheral opening groove; and

a silicone sleeve attached closely to the other surfaces of the electronic product, wherein the silicone sleeve has an opening extending towards a contact surface between the electronic product and the panel, and a flange of the opening of the silicone sleeve is embedded into the peripheral opening groove of the panel.

Preferably, the panel is a plastic panel.

Preferably, a portion of the plastic panel corresponding to lens of the electronic product is transparent.

Preferably, the panel is a metallic panel.

Preferably, a portion of the metallic panel corresponding to lens of the electronic product is inlayed with a tempered glass sheet.

Preferably, the peripheral opening groove of the panel is in a vertical direction.

Preferably, the peripheral opening groove of the panel is in a horizontal direction.

Preferably, a portion of the silicone sleeve corresponding to a screen of the electronic product is a transparent silicone portion.

Preferably, the silicone sleeve is transparent.

Preferably, the silicone sleeve has a hole corresponding to an external connector of the electronic product and slightly smaller than an outer diameter of an earphone plug, and a rubber plug is provided for matching with the hole.

The present invention greatly reduces the usage of panel materials and effectively reduces the thickness, weight and cost of the products by setting the combination of a silicone sleeve and a panel. It forms an internal closed cavity to accommodate the electronic product which needs waterproof by using the elastic contraction of the silicone sleeve and the combination of its edging into the opening grooves of the panel. The utilization of transparent materials can not interfere with the usage of various functions of electronic products.

### BRIEF DESCRIPTION OF THE DRAWINGS

FIG. 1 is a sectional schematic view of the present invention according to the embodiments.

FIG. 2 is a front schematic view in FIG. 1.

FIG. 3 is a top schematic view in FIG. 1.

FIG. 4 is a back schematic view in FIG. 1.

FIG. 5 is an assembly schematic view of the present invention according to the first embodiment.

FIG. 6 is an assembly schematic view of the present invention according to the second embodiment.

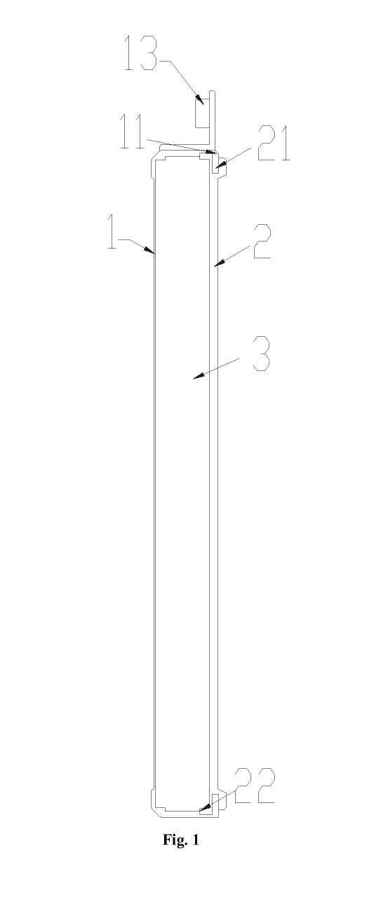

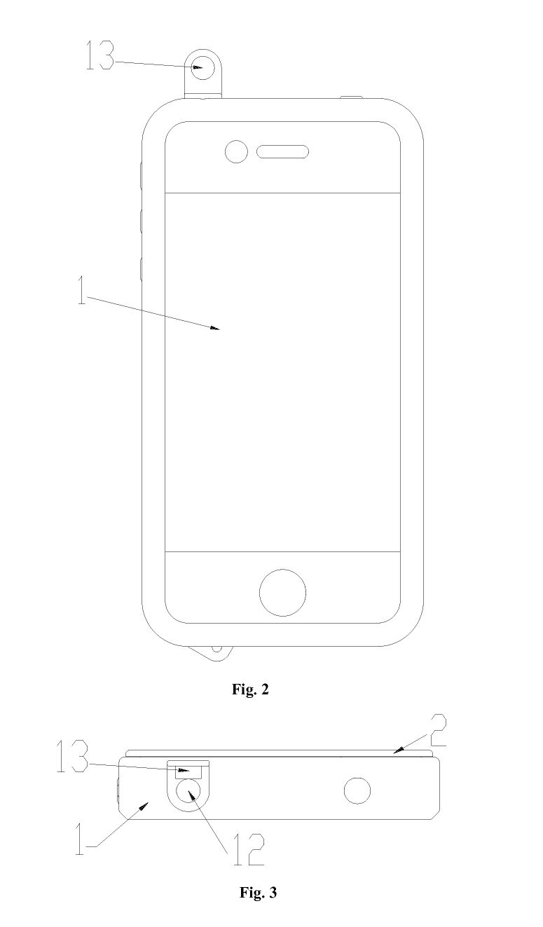

### DETAILED DESCRIPTION OF THE PREFERRED EMBODIMENTS

The embodiment of the present invention discloses the waterproof device for an electronic product by taking the waterproof device for mobile phone as an example and with reference to accompanying drawings in the following:

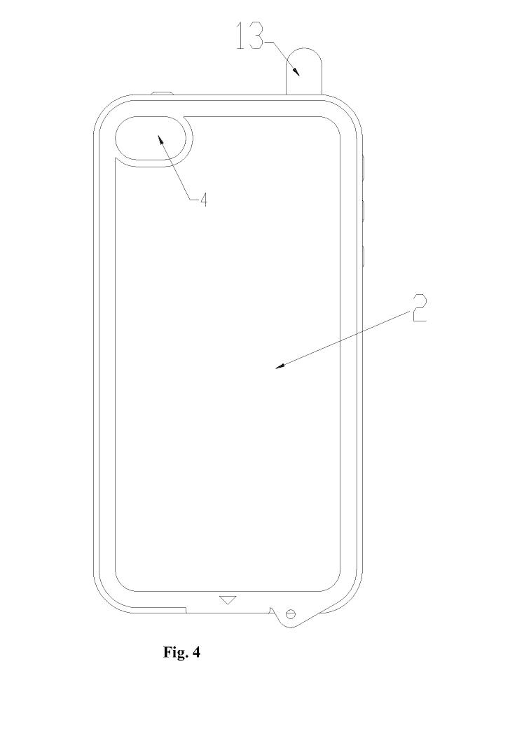

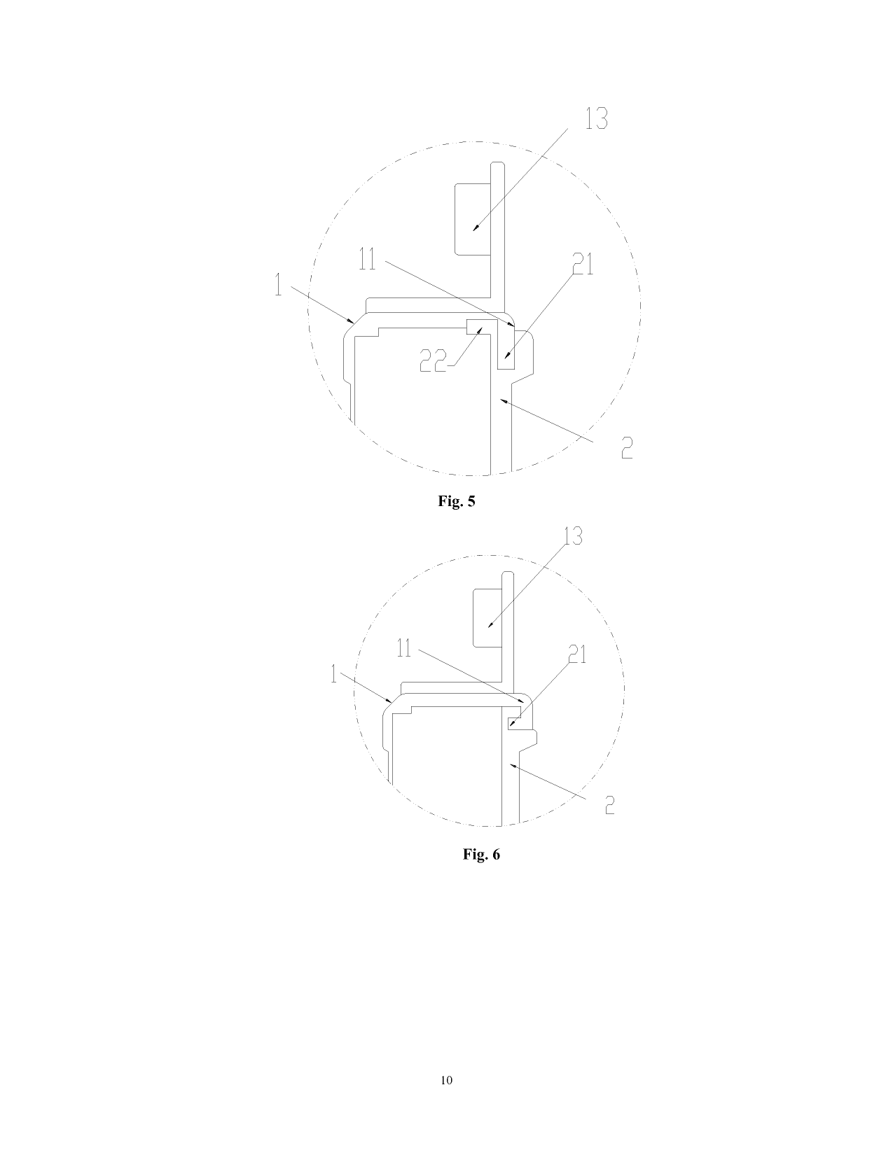

The waterproof device comprises a transparent silicone sleeve 1 with a C-shaped section and a panel 2 with a peripheral opening groove 21, the panel is fixed on the surface of mobile phone through a fixing assembly 22. The flange of the opening 11 of the silicone sleeve 1 is embedded into the opening groove 21 of the panel 2, thus forming an internal closed cavity 3 to accommodate a mobile phone which needs to be waterproofed by using the elastic contraction of the silicone sleeve 1 and the cooperation of the silicone sleeve 1 and the opening groove of the panel 2. The cavity 3 is closely matched with the mobile phone, and the transparency and flexibility of the silicone sleeve 1 can meet the requirements of visible display screen and operable key for mobile phone. For the external earphone of mobile phone, the corresponding position on transparent silicone sleeve 1 has a hole 12 which is slightly smaller than the outer diameter of the earphone plug, and seals the hole 12 with a rubber plug 13 on the silicone sleeve 1 or a separate one to achieve the waterproof effect. Pulling off the rubber plug 13 and then inserting the earphone plug is also waterproof. The panel 2 can be made of transparent plastic materials or metallic materials, which is for the assembly of transparent silicone sleeve 1 together to form the closed cavity 3. If the panel 2 is made of metallic materials, the portion of corresponding to the lens of the electronic product can be inlayed with a tempered glass sheet 4 to meet the requirement of shoot (FIG. 4). The peripheral opening groove 21 in the panel can be in a vertical direction (FIG. 5) or horizontal direction (FIG. 6), and the transparent silicone sleeve 1 also has corresponding mating structure.

The above description is only for preferred applicable embodiments of the present invention, but not limited within the application scope of the present invention, and any other modification, equivalent replacement or improvement within the spirit and principle disclosed in present invention should be included in the protection scope of the present invention.

What is claimed is:

1. A waterproof device for an electronic product, comprising:
a panel with one side of the panel attached closely to one surface of the electronic product, and with a peripheral opening groove; and
a silicone sleeve attached closely to the other surfaces of the electronic product, wherein the silicone sleeve has an opening extending towards a contact surface between the electronic product and the panel, and a flange of the opening of the silicone sleeve is embedded into the peripheral opening groove of the panel.

2. The waterproof device of claim 1, wherein the panel is a plastic panel.

3. The waterproof device of claim 2, wherein a portion of the plastic panel corresponding to lens of the electronic product is transparent.

4. The waterproof device of claim 1, wherein the panel is a metallic panel.

5. The waterproof device of claim 4, wherein a portion of the metallic panel corresponding to lens of the electronic product is inlayed with a tempered glass sheet.

6. The waterproof device of claim 1, wherein the peripheral opening groove of the panel is in a vertical direction.

7. The waterproof device of claim 1, wherein the peripheral opening groove of the panel is in a horizontal direction.

8. The waterproof device of claim 1, wherein a portion of the silicone sleeve corresponding to a screen of the electronic product is a transparent silicone portion.

9. The waterproof device of claim 1, wherein the silicone sleeve is transparent.

10. The waterproof device of claim 1, wherein the silicone sleeve has a hole corresponding to an external connector of the electronic product and slightly smaller than an outer diameter of an earphone plug, and a rubber plug is provided for matching with the hole.
